(19) United States
(12) Patent Application Publication
(10) Pub. No.: US 2020/0347841 A1
(43) Pub. Date: Nov. 5, 2020

(54) CRANKSHAFT

(71) Applicant: Secop GmbH, Flensburg (DE)

(72) Inventors: Peter SCHÖLLAUF, Graz (AT); Daniela ZACH, Riegersburg (AT)

(73) Assignee: Secop GmbH, Flensburg (DE)

(21) Appl. No.: 16/963,076

(22) PCT Filed: Jan. 17, 2019
(86) PCT No.: PCT/EP2019/051170

§ 371 Date: Jul. 17, 2020

(30) Foreign Application Priority Data
Jan. 19, 2018 (EP) 18152541.1

(51) Int. Cl. F04B 39/02; F16C 3/14

(52) U.S. Cl. CPC F04B 39/0276; F16C 3/14

(57) ABSTRACT

A crankshaft (1) for a refrigerant compressor, the crankshaft (1) at least comprising a cylindrical shaft element (2), a crankpin (3) for driving a compressor piston of the refrigerant compressor, and means for conveying lubricant from a lower end region (4), facing away from the crankpin (3), of the shaft element (2) in the direction of the crankpin (3), in order to supply lubricant to movable parts of the refrigerant compressor, wherein at least one surface section of a surface of the crankshaft (1) comprises at least one flow disruptor, which flow disruptor is, based on the geometry and/or characteristics thereof, configured to break up vapor bubbles and/or gas bubbles in the lubricant flowing around the crankshaft (1) in an operating state of the refrigerant compressor.

### FIELD OF THE INVENTION

The present invention relates to a crankshaft for a refrigerant compressor, the crankshaft at least comprising a cylindrical shaft element, a crankpin for driving a compressor piston of the refrigerant compressor, and means for conveying lubricant from a lower end region, facing away from the crankpin, of the shaft element in the direction of the crankpin, in order to supply lubricant to movable parts of the refrigerant compressor.

### PRIOR ART

Crankshafts of the type named at the outset are normally used in compressors, for example refrigerant compressors. They thereby perform two functions: On the one hand, they serve to transmit forces produced by a drive unit to a compression mechanism of the compressor; they also perform the function of lubricating movable components of the compressor, such as a cylinder/piston unit and a connecting rod of the compression mechanism as well as a bearing of the compressor, in which bearing the crankshaft is rotatably mounted.

Lubricant that is located in the compressor and forms a lubricant sump in a base region of a compressor housing in an operating state of the compressor, in which state the compressor is operated as intended, is thereby conveyed from the lubricant sump in the direction of the compression mechanism via suitable means of the rotating crankshaft and subsequently reaches, via outlet openings of a shaft element of the crankshaft, the locations of the bearing that are to be lubricated and, via a crankpin of the crankshaft, the locations of the compression mechanism that are to be lubricated. The conveyed lubricant then drips off of the lubricated components of the compressor and returns—also via the crankshaft, among other things—to the lubricant sump.

Due to the high speeds at which the crankshaft rotates, the static pressure of the lubricant in the region of the crankshaft decreases sharply, which in turn results in a lower evaporation temperature of the lubricant. Gas bubbles therefore form in the lubricant, which gas bubbles are relatively stable due to the gases dissolved in the lubricant (soft or stable gas cavitation). These gas bubbles can completely or partially wear out the means for conveying lubricant in or on the shaft (for example, helical grooves on a surface of the shaft element or bores in the interior of the crankshaft). This in turn results in wear of the movable components of the compressor, as a sufficient amount of lubricant can no longer be conveyed to said components that are to be lubricated. Ultimately, the described problem increases the failure rate of compressors.

### OBJECT OF THE INVENTION

It is therefore an object of this invention to provide a crankshaft of the type named at the outset through which the probability of failure of a compressor in which the crankshaft is used due to cavitation of the lubricant can be reduced.

### DESCRIPTION OF THE INVENTION

This object is attained with a crankshaft according to the invention for a compressor, preferably for a refrigerant compressor, the crankshaft comprising at least
a cylindrical shaft element,
a crankpin for driving a compressor piston of the refrigerant compressor, and
means for conveying lubricant from a lower end region, facing away from the crankpin, of the shaft element in the direction of the crankpin, in order to supply lubricant to movable parts of the refrigerant compressor,
in that at least one surface section of a surface of the crankshaft comprises at least one flow disruptor, which flow disruptor is, based on the geometry and/or characteristics thereof, configured to break up vapor bubbles and/or gas bubbles in the lubricant flowing around the crankshaft in an operating state of the refrigerant compressor.

The crankshaft according to the invention thus comprises at least one, preferably multiple, flow disruptors in order to cause vapor bubbles and/or gas bubbles that have formed in the lubricant by cavitation to collapse. For this purpose, all flow disruptors are arranged on surface sections of the surface of the crankshaft, around which or through which surface sections lubricant flows in the operating state of the compressor, in which state the compressor is operated as intended. The vapor bubbles and/or gas bubbles in the lubricant that have formed in the lubricant by cavitation and are hereinafter subsumed in the term “gas bubbles” for the sake of simplicity, thus pass at least one flow disruptor when the lubricant surrounding them is guided through the means for conveying lubricant from the lubricant sump in the direction of the crankpin and/or runs off back into the lubricant sump via the crankshaft. When a flow disruptor is passed, the geometry and/or (surface) characteristics thereof cause the passing gas bubble to be deformed or disrupted so strongly that it collapses. The inclusion according to the invention of flow disruptors on the surface of the crankshaft thus leads to a reduction of the probability of a (periodic) obstruction of the means for conveying lubricant of the crankshaft, which in turn ensures a continuous conveying of lubricant and, as a result, also a sufficient lubrication of the movable components of the compressor.

In a preferred embodiment of the crankshaft according to the invention, it is provided that a means for conveying lubricant is embodied by a helical conveying groove of the shaft element, which conveying groove circles the longitudinal axis of the shaft element, wherein the conveying groove is part of the surface section and comprises the at least one flow disruptor or at least one of the flow disruptors.

The conveying groove embodied as a helical groove serves to convey the lubricant in the direction of the crankpin, that is, in an axial direction along the longitudinal axis of the shaft element, over a large portion of the longitudinal extension of the shaft element. The conveying groove thereby begins in the lower end region of the shaft element and merges into a pass-through opening of the crankshaft, which pass-through opening enables the passage of lubricant from the conveying groove into the crankpin, in an upper end region of the shaft element, which upper end region is positioned upstream of a transition element that is arranged between the shaft element and the crankpin and is used for balancing. The arrangement of one or more flow disruptors in the conveying groove renders it possible for the quantity of gas bubbles in the lubricant transported in the direction of the crankpin by means of the conveying groove to be reduced considerably and for the risk of a clogging of the conveying groove and/or the pass-through opening by such gas bubbles to be minimized.

Particularly preferably, it is thereby provided that the at least one flow disruptor or at least one of the flow disruptors is arranged on a base of the conveying groove. Alternatively or additionally thereto, flow disruptors can also be arranged on a wall of the conveying groove.

Depending on the specific implementation of the flow disruptors, this arrangement of the flow disruptors can simplify the fabrication of the crankshaft according to the invention considerably.

In another preferred embodiment of the crankshaft according to the invention, it is provided that a means for conveying lubricant is embodied by a bore that is preferably eccentrically arranged, particularly preferably running transversely to the longitudinal axis of the shaft element, wherein an inner surface of the bore, which inner surface defines the bore, is part of the surface section and comprises at least one flow disruptor. Thus, one or more flow disruptors can be arranged solely in the bore, or one or more flow disruptors can additionally be arranged in other locations. In this context, transversely means forming an angle not equal to 0° or 180° to the longitudinal axis of the shaft element.

Typically, lubricant is conveyed from the lubricant sump to a first outlet opening of the shaft element via a bore in the end region, which extends into the lubricant sump, of the shaft element, said bore being what is referred to as the eccentric bore. At this first outlet opening, the exiting lubricant can be transferred into the conveying groove for the purpose of further conveying in the direction of the crankpin and/or can be used to lubricate a bearing of the compressor located in the region of the first outlet opening, in which bearing the crankshaft is rotatably mounted. The inner surface of the bore, which inner surface defines this bore, is itself part of the surface section of the crankshaft and, as such, can comprise one or more flow disruptors—as is the case in the last preferred embodiment described. It is thus ensured that the lubricant entering into the crankshaft from the lubricant sump via the bore is freed of gas bubbles to the greatest possible extent and neither the first outlet opening nor the conveying groove can be obstructed by gas bubbles.

In another preferred embodiment of the crankshaft according to the invention, it is provided that an outer envelope surface of the shaft element is part of the surface section and comprises the at least one flow disruptor or at least one of the flow disruptors.

A considerable portion of the lubricant conveyed for the lubrication of a compression mechanism—for example, the compressor piston that moves back and forth between two dead centers in a cylinder and/or a connecting rod that facilitates the required operative connection between the crankpin and the compressor piston—drains off again via the crankshaft, more precisely via the outer envelope surface of the shaft element, in order to ultimately return to the lubricant sump. However, it can occur that cavitation and therefore bubbling in the lubricant arise due to the high rotational speed of the crankshaft. The gas bubbles formed thereby would then return to the lubricant sump with the lubricant draining off, so that the bore, namely the eccentric bore, runs the risk of becoming partially blocked or even completely clogged. In both cases, the supply of a sufficient amount of lubricant to the components of the compressor that are to be lubricated would no longer be ensured. Due to the arrangement of flow disruptors on the outer envelope surface, the lubricant running off is freed of gas bubbles before it can return to the lubricant sump and before the gas bubbles have an opportunity to block the lubricant supply—that is, the means of conveying lubricant.

In a particularly preferred embodiment of the crankshaft according to the invention, it is provided that at least one flow disruptor is arranged in a free section of the outer envelope surface of the shaft element, wherein the shaft element has in the region of the free section a smaller diameter than in the region of a mounting section of the shaft element used to mount the crankshaft in the refrigerant compressor and/or of the end region.

Thus, one or more flow disruptors can be arranged in the free section of the outer envelope surface, or one or more flow disruptors can additionally be arranged in other locations. Flow disruptors that are arranged in the free section have the advantage that the geometry and/or the surface characteristics thereof are subject to a greater freedom of design than flow disruptors that are arranged in a different location of the outer envelope surface of the shaft element. For example, these flow disruptors can protrude from the shaft element in a radial direction to a greater extent and can thus be embodied to be taller than in the case of flow disruptors that, for example, are arranged in the region of the mounting section, fabricated for a precise fit, or of the end region of the shaft element. In addition, flow disruptors arranged in the free section also offer an advantage because the conveying groove is typically mainly arranged in the free section. That lubricant which does not return back to the lubricant sump, but rather is already fed into the conveying groove again beforehand to then be conveyed in the direction of the crankpin, first passes the flow disruptors arranged in the free section in this embodiment of the crankshaft according to the invention. As a result, gas bubbles potentially present in the lubricant can be broken up and the conveying groove as well as the pass-through opening can be protected against obstruction.

According to another particularly preferred embodiment of the crankshaft according to the invention, it is provided that at least one flow disruptor is embodied as a raised section and/or a recess of the surface section.

Thus, one or more flow disruptors can be embodied as a raised section and/or a recess of the surface section, or one or more flow disruptors can additionally be embodied in a different form.

In another particularly preferred embodiment of the crankshaft according to the invention, it is provided that the at least one flow disruptor or at least one of the flow disruptors is embodied by a groove.

This groove can be arranged on the surface section, for example inside the conveying groove, on the inner surface of the bore, on the inside of the pass-through opening, on the outer envelope surface of the shaft element, and/or in the free section of the outer envelope surface of the shaft element (outside of the conveying groove), and can form the at least one flow disruptor or one of the flow disruptors. Through the groove-form design, the groove can be adapted to the requirements of the operating state of the compressor and/or to the lubricant used in each case. The groove can thereby respectively extend over only a part of the respective surface section, or can mostly or also essentially completely cover said section. The term “groove” thereby representatively signifies any form of an elongated (continuous or even interrupted) recess on the surface section of the surface of the crankshaft.

Basically, the groove can have any desired shape and design, provided that a sufficient disruption of the gas bubbles present in the lubricant is ensured. However, it is particularly advantageous if, as is provided in another preferred embodiment of the crankshaft according to the invention, the groove has a smaller groove depth than the conveying groove.

In this manner, a sufficient disruption of the lubricant flow is ensured, as a result of which disruption gas bubbles in the lubricant that were produced by cavitation are broken up.

In another preferred embodiment, particular advantages with regard to a simpler fabrication of the crankshaft arise in that the groove is embodied to be helical and circles the longitudinal axis of the shaft element.

This groove is thus also embodied as a helical groove, wherein the groove can differ from the conveying groove in regard to shape, groove depth, and pitch.

In a preferred embodiment of the crankshaft according to the invention, it is for example provided that the groove has a smaller pitch, preferably by at least a factor of 10, than the conveying groove.

As a result, the respective surface section is deformed such that gas bubbles in the lubricant flowing around the crankshaft in the operating state of the compressor are efficiently broken up.

Particularly preferably, it is provided in another embodiment of the crankshaft according to the invention that the at least one flow disruptor or at least one of the flow disruptors is embodied by a furrow or score, preferably one group each of furrows or scores arranged parallel to one another.

With the embodiment of the flow disruptor as a furrow or score, a particularly simple fabrication of the flow disruptor is rendered possible. All surface sections on which flow disruptors are to be arranged are for this purpose respectively provided with a furrow or score running in any desired direction, whereby the surface sections are respectively provided with a fourth-order form deviation in the case of a furrow and with a third-order form deviation in the case of a score (DIN 4760), and therefore with a certain surface roughness in both cases.

It is particularly preferred if the at least one flow disruptor or at least one of the flow disruptors is respectively embodied by a group of furrows or scores arranged parallel to one another.

In another particularly preferred embodiment of the crankshaft according to the invention, a corresponding disruption of the lubricant flow can also be achieved in that at least one of the flow disruptors is embodied by at least one adhesive dot and/or welded dot, preferably by a plurality of adhesive dots and/or welded dots, which at least one adhesive dot and/or welded dot protrudes from the surface section of the crankshaft.

Thus, one or more flow disruptors can be embodied by at least one adhesive dot and/or welded dot, or one or more flow disruptors can additionally be embodied in a different form. This embodiment is distinguished by a particularly high degree of flexibility in regard to the design of the flow disruptors. Both the outer envelope surface of the shaft element and also the free section and/or the inner surface of the bore can be provided with corresponding adhesive dots and/or welded dots, wherein the embodiment of each individual adhesive dot or welded dot can be different. The flow disruptors embodied in such a manner can thereby also be arranged in large part or solely on surface sections, the characteristics of which are of particular importance in regard to the stability of the lubricant flow.

Thus, through the placement of a small number of flow disruptors on these types of critical surface sections, the desired effect can already be achieved—namely, a breaking-up of most or all of the gas bubbles in the lubricant that flows around the crankshaft in the operating state of the compressor.

The object on which the invention is based is also attained by a compressor, preferably a refrigerant compressor, having a crankshaft of the type described above.

### BRIEF DESCRIPTION OF THE FIGURES

The invention will now be explained in greater detail with the aid of exemplary embodiments. The drawings are by way of example and are intended to demonstrate, but in no way restrict or exclusively describe, the inventive concept.

In this matter:

FIG. 1 shows a crankshaft according to the invention;

FIG. 2 shows the crankshaft from FIG. 1 in a side view;

FIG. 3 shows the crankshaft from FIG. 1 in a top view;

FIG. 4 shows a crankshaft according to the invention with a flow disruptor embodied as a groove;

FIG. 5 shows a further crankshaft according to the invention with a flow disruptor embodied as a groove;

FIG. 6 shows another crankshaft according to the invention with flow disruptors embodied as a group of scores;

FIG. 7 shows a bore 7 in a cut-away view of the end region of the crankshaft; and

FIG. 8 shows an expanded view of portion A depicted in FIG. 7.

### WAYS OF EMBODYING THE INVENTION

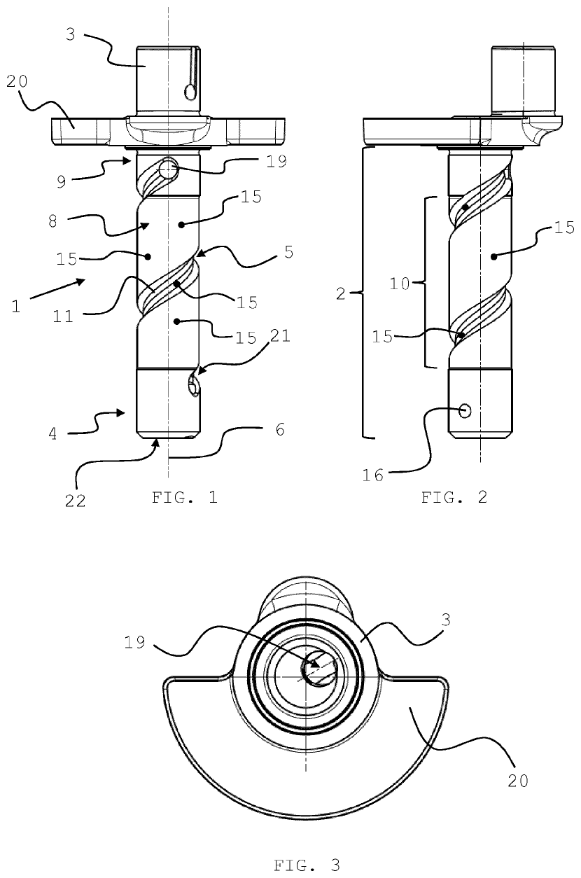

FIGS. 1 through 3 show a crankshaft 1 according to the invention for a compressor, preferably a refrigerant compressor, having a cylindrical shaft element 2, a crankpin 3, and a transition element 20 that is arranged between the crankpin 3 and the shaft element 2 and serves to balance the crankshaft 1. The crankshaft 1 comprises, in the form of a conveying groove 5, means for conveying lubricant in order to convey lubricant from a lower end region 4, facing away from a crankpin 3, of a shaft element 2 in the direction of the crankpin 3.

The conveying groove 5 is embodied as a helical groove and circles a longitudinal axis 6 of the cylindrical shaft element 2. It thereby begins in the end region 4 of the shaft element 2, namely in an outlet opening 21, and merges into a pass-through opening 19 in a mounting section 9 of the shaft element 2, which mounting section 9 is adjacent to the transition element 20.

The outlet opening 21 renders it possible that lubricant which was conveyed via a bore 7 (not illustrated)—see FIGS. 7 and 8—from a lubricant sump into the interior of the shaft element 2 in an operating state of the refrigerant compressor can exit the shaft element 2 and spill over into conveying groove 5 in order to be further conveyed in the direction of the crank pin 3. For this purpose, the outlet opening 21 is connected to the bore 7. The bore 7 itself is preferably an eccentric bore running transversely to the longitudinal axis 6 of the shaft element 2, which eccentric bore extends in the shaft element 2 from a bottom base surface 22 of the shaft element 2. A longitudinal axis 17 of the bore 7 thereby forms an angle of approximately 10° with the longitudinal axis 6 of the shaft element 2 in the exemplary embodiment shown. In the operating state of the refrigerant compressor, the crankshaft 1 extends, with the end region 4 thereof, but at least with the base surface 22, into the lubricant sump, so that lubricant is conveyed to the outlet opening 21 via the bore 7 by the rotation of the shaft 1.

From FIGS. 2, 7, and 8, it can be seen that the crankshaft 1 comprises in the end region 4 of the shaft element 2 an additional bore 16 that enables a supply of lubricant to a bearing of the refrigerant compressor in which the crankshaft 1 is rotatably mounted by means of the end region 4. A longitudinal axis 18 of the additional bore 16 thereby essentially runs orthogonally to the longitudinal axis 6 of the shaft element 2.

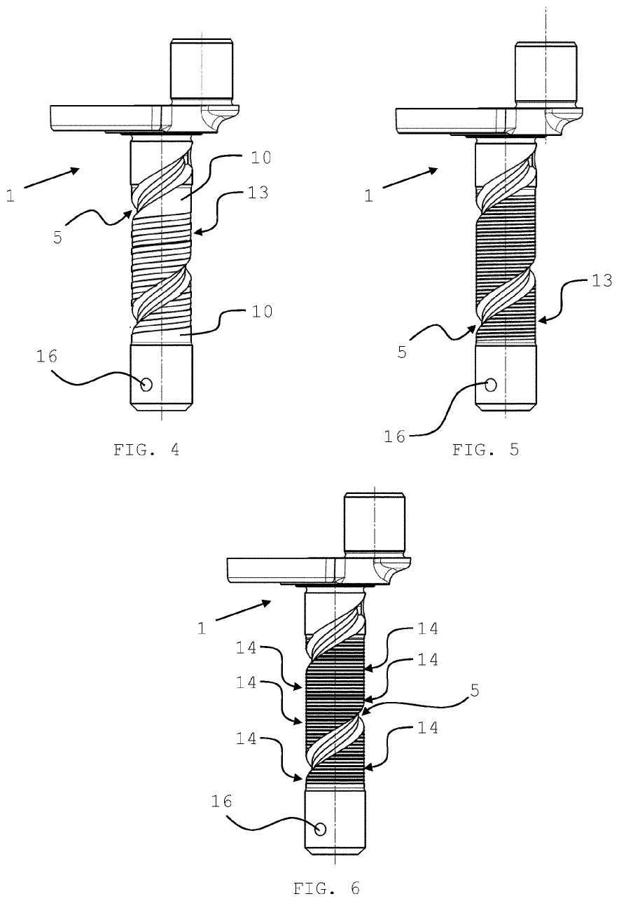

Via the pass-through opening 19 into which the conveying groove 5 merges, the lubricant ultimately reaches the crankpin 3, which is typically embodied as a hollow cylinder and is therefore open in an upward direction (see FIG. 3). The conveyed lubricant can exit the crankshaft 1 via the crankpin 3 and lubricate the movable components of the compression mechanism, for example a compressor piston, or a bearing of the refrigerant compressor in which the crankshaft 1 is rotatably mounted by means of the mounting section 9.

The lubricant then runs off from the compression mechanism or from the movable components of the refrigerant compressor and returns to the lubricant sump, where it is available for renewed conveying in the direction of the crankpin 3. One portion of the lubricant thereby runs off via an inside of a compressor housing; another portion via the crankshaft 1, or more precisely, via a surface of the crankshaft 1. The term “surface” denotes the entirety of all boundary surfaces of the crankshaft 1. In particular, the lubricant can run off via an outer envelope surface 8 of the shaft element 2 or via inner surfaces 12 of the bore 7 or the pass-through opening 19 on the crankshaft 1.

As a result of the high rotational speed of the crankshaft 1 in the operating state of the refrigerant compressor 1, there occurs, particularly in the boundary layer between the surface of the crankshaft 1 and the lubricant, a significant decrease in the static pressure in the lubricant, which in turn leads to a markedly lower evaporation temperature of the lubricant. The operating temperature present in the housing interior in the operating state of the refrigerant compressor is therefore already sufficient to evaporate portions of the lubricant in the region of the boundary layer so that gas bubbles can form in the lubricant. This phenomenon is referred to as cavitation, and can result in the components of the refrigerant compressor being damaged by the implosion of the gas bubbles formed. In connection with compressors, such gas bubbles can cause a failure of the supply of lubricant to the movable components of the compressor that are to be lubricated, since the gas bubbles formed can partially or even fully block the means for conveying lubricant.

To counteract the bubble formation described above, and to destabilize gas bubbles that have already formed and cause them to collapse, it is provided according to the invention that at least one surface section of the surface of the crankshaft 1 comprises at least one flow disruptor. The geometry and/or the characteristics of the flow disruptor cause—in combination with a corresponding positioning of the at least one flow disruptor or at least one of the flow disruptors—the gas bubbles in the lubricant flowing around the crankshaft 1 to be destabilized and broken up.

For example, the flow disruptors can be realized by adhesive dots 15 in the interior of the conveying groove 5, namely on a base 11 and/or a wall of the conveying groove 5 (see FIGS. 1 and 2). In this manner, lubricant that enters into the conveying groove 5 is reliably freed of gas bubbles. A clogging of the conveying groove 5 itself or of the pass-through opening 19 with gas bubbles can thus be avoided. Similarly, the arrangement of the adhesive dots 15 can be provided on the inner surface 12 of the bore 7 in order to already free the lubricant of potential gas bubbles during the inflow into the crankshaft 1.

However, the at least one flow disruptor or at least one of the flow disruptors can also be embodied by an additional groove 13, which groove 13 is arranged on the outer envelope surface 8 of the shaft element 2. In particular, the groove 13 can be arranged in a free section 10 of the shaft element 2, wherein the free section 10 extends between the end region 4 and the mounting section 9 of the shaft element 2 and comprises a slightly smaller diameter than the mounting section 9 and/or the end section 4. Embodiments of the crankshaft 1 according to the invention with a groove 13 that is arranged in the free section 10 and functions as a flow disruptor are illustrated in FIGS. 4 and 5.

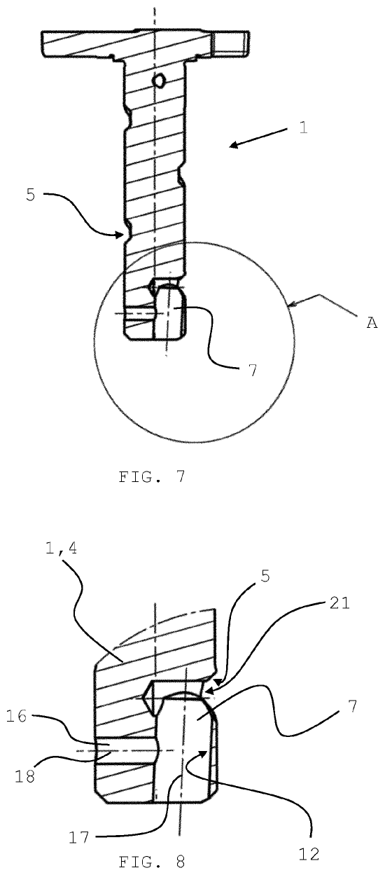

The at least one flow disruptor or at least one of the flow disruptors can also be embodied by scores 14 or furrows, or by a group of scores 14 running parallel to one another as in the exemplary embodiment illustrated in FIG. 6, that are arranged on the outer envelope, in particular the free section 10, of the shaft element 2. The shaft element 2 is thus imparted with a surface roughness which causes gas bubbles in the lubricant flowing around it to be broken up.

Of course, crankshafts 1 in which the groove 13 and/or the furrows or scores 14 are arranged on other surface sections, for example on the inner surface 12 of the bore 7 or the pass-through opening 19, are also included in the inventive concept.

FIG. 7 shows a crankshaft 1 according to the invention in a sectional view, in which the bore 7 is visible.

FIG. 8 shows Detail A from FIG. 7. The bore 7 arranged in the end region 4 of the shaft element 2, the additional bore 16, and the outlet opening 21 enabling the inflow of lubricant into the conveying groove 5 can thereby be seen.

### LIST OF REFERENCE NUMERALS

1 Crankshaft

2 Shaft element

3 Crankpin

4 End region

5 Conveying groove

6 Longitudinal axis

7 Bore

8 Outer envelope surface

9 Mounting section

10 Free section

11 Base of the conveying groove

12 Inner surface of the bore

13 Groove

14 Score

15 Adhesive dot

16 Additional bore

17 Longitudinal axis of the bore

18 Longitudinal axis of the additional bore

19 Pass-through opening

20 Transition element

21 Outlet opening

22 Base surface

1. A crankshaft for a refrigerant compressor, the crankshaft at least comprising
a cylindrical shaft element,
a crankpin for driving a compressor piston of the refrigerant compressor, and
a conveyor conveying lubricant from a lower end region, facing away from the crankpin, of the shaft element in the direction of the crankpin, in order to supply lubricant to movable parts of the refrigerant compressor,
wherein at least one surface section of a surface of the crankshaft comprises at least one flow disruptor, which flow disruptor is, based on the geometry and/or characteristics thereof, configured to break up vapor bubbles and/or gas bubbles in the lubricant flowing around the crankshaft in an operating state of the refrigerant compressor.

2. The crankshaft according to claim 1, wherein the conveyor conveying lubricant is embodied by a helical conveying groove of the shaft element, which conveying groove circles the longitudinal axis of the shaft element, wherein the conveying groove is part of the surface section and comprises at least one flow disruptor.

3. The crankshaft according to claim 2, wherein at least one flow disruptor is arranged on a base of the conveying groove and/or on a wall of the conveying groove.

4. The crankshaft according to claim 1, wherein the conveyor conveying lubricant is embodied by a bore that is preferably eccentrically arranged, particularly preferably running transversely to the longitudinal axis of the shaft element, wherein an inner surface of the bore, which inner surface defines the bore, is part of the surface section and comprises at least one flow disruptor.

5. The crankshaft according to claim 1, wherein an outer envelope surface of the shaft element is part of the surface section and comprises at least one flow disruptor.

6. The crankshaft according to claim 5, wherein at least one flow disruptor is arranged in a free section of the outer envelope surface of the shaft element, wherein the shaft element has in the region of the free section a smaller diameter than in the region of a mounting section of the shaft element and/or of the end region, whereas the mounting section is used to mount the crankshaft in the refrigerant compressor.

7. The crankshaft according to claim 1, wherein at least one flow disruptor is embodied as a raised section and/or a recess of the surface section.

8. The crankshaft according to claim 1, wherein at least one of the flow disruptors is embodied by a groove.

9. The crankshaft according to claim 8, wherein the groove has a smaller groove depth than the conveying groove.

10. The crankshaft according to claim 8, wherein the groove is embodied to be helical and circles the longitudinal axis of the shaft element.

11. The crankshaft according to claim 10, wherein the groove has a smaller pitch, preferably by at least a factor of 10, than the conveying groove.

12. The crankshaft according to claim 1, wherein at least one of the flow disruptors is embodied by a furrow or score, preferably one group each of furrows or scores arranged parallel to one another.

13. The crankshaft according to claim 1, wherein at least one flow disruptor is embodied by at least one adhesive dot and/or welded dot, preferably by a plurality of adhesive dots and/or welded dots, which at least one adhesive dot and/or welded dot protrudes from the surface section of the crankshaft.

14. A compressor, preferably a refrigerant compressor, having a crankshaft according to claim 1.
